(19) United States
(12) Patent Application Publication
(10) Pub. No.: US 2005/0259537 A1
(43) Pub. Date: Nov. 24, 2005

(54) Method and apparatus of determining writing power for a recording medium

(76) Inventor: Joung Woo Kim, Suwon-si (KR)

Correspondence Address: FLESHNER & KIM, LLP, P.O. BOX 221200, CHANTILLY, VA, 20153, US

(21) Appl. No.: 11/131,430

(22) Filed: May 18, 2005

(30) Foreign Application Priority Data
May 19, 2004 (KR) 04-35714

(51) Int. Cl. G11B 5/09; G11B 7/00

(52) U.S. Cl. 369/47.5; 369/116; 369/53.1; 369/47.53

(57) ABSTRACT

Embodiments of a method and apparatus of determining writing power for an optical disk are disclosed where a relationship (e.g., linear coefficient) for finding optimal writing power according to recording position can be detected at a recording speed and an optimal power calibration operation can be performed at each of other recording speeds. When data is recorded at an area with a certain recording speed, the optimal writing power at the area for the recording speed can be calculated using the linear coefficient and the calculated optimal writing power is used.

### BACKGROUND OF THE INVENTION

1. Field of the Invention

The present invention relates to a method and apparatus of determining writing power for a recording medium such as an optical disk.

2. Background of the Related Art

The jitter of data reproduced from an optical disk is significantly affected by the writing power used during data recordation. An optical disk has information recorded thereon about a reference writing power setting for the standard rotational speed of the optical disk in order to obtain the best writing quality. A disk reproducing apparatus, therefore, can utilize the recorded information to set the writing power when recording data on the optical disk.

With rapid advances of the recording technology, a related art zone-CLV recording method has emerged as an effective method to increase recording speed. The zone-CLV is a method for data writing in which the writing area within an optical disk is divided into a plurality of zones and data recording is performed at different speeds at different zones. As FIGS. 1 and 2 illustrate, the recording speed in zone I-a is 4× speed and the recording speed in zone a-b is 8× speed. Similarly, the recording speed at zone c-O is maximum 16× speed. The maximum rotational speed in each zone, however, is identical.

Because the recording speed changes within a disk as shown in FIG. 1, it is almost impossible to cope with various recording speeds using only the information about the reference writing power for the standard speed recorded on the optical disk. Further, a writing power considered to be optimal in inner tracks of an optical disk may not be optimal in outer tracks of the optical disk because the characteristics of the optical disk change from inner to outer tracks.

For this reason, optical disk reproducing apparatus store optimal writing power data according to disk manufacturers (or disk codes), disk recording speeds, and zones in nonvolatile memory included therein and utilize the optimal writing power data when recording data. The optimal writing power data stored in the memory is obtained through recording tests.

The method described above, however, has various disadvantages. For example, the method requires increasing nonvolatile memory size as the number of disk types increases, which may result in insufficient memory space. In addition, the optimal writing power data stored in nonvolatile memory does not take account of changes in the optical characteristics of recording apparatuses and variation of disk characteristics. Therefore, the writing power data may cause a significant decrease in writing quality if used inappropriately. Further, the method cannot provide optimal writing quality for disks where the optimal writing power information is not stored in memory.

The above references are incorporated by reference herein where appropriate for appropriate teachings of additional or alternative details, features and/or technical background.

### SUMMARY OF THE INVENTION

An object of the invention is to solve at least the above problems and/or disadvantages or to provide at least the advantages described hereinafter.

Another object of the present invention is to provide a method and apparatus of determining writing power at a plurality of recording speeds of an optical disk without using pre-stored writing power data.

Another object of the present invention is to provide a method and apparatus of determining writing power by detecting a linear coefficient for writing power according to a first recording position at a first recording speed and performing power calibration (PC) only once per recording speed to reduce the time required to run the PC.

To achieve at least the above objects or advantages in a whole or in part and in accordance with the purpose of the invention, as embodied and broadly described herein there is provided a method that includes obtaining a linear coefficient of writing power for a recording medium at a first speed, detecting a writing power at a first area of the recording medium for a second speed other than the first speed and determining a writing power at a recording area other than the first area for the second speed using the detected linear coefficient and the detected writing power for the second speed.

To further achieve at least the above objects or advantages in a whole or in part and in accordance with the purpose of the invention, as embodied and broadly described herein there is provided an apparatus that includes an optical pickup configured to record signals on the recording medium and read the recorded signals from the recording medium, an optical driver configured to provide the optical pickup with electrical current that determines the strength of the recorded signals according to a control signal, a drive unit configured to rotate the recording medium and a controller configured to detect a linear coefficient of writing power for the recording medium while rotating the recording medium at a first recording speed using the drive unit, detect a first writing power at a first area of the recording medium while rotating the recording medium at a second recording speed different from the first recording speed using the drive unit, determine a second writing power at a second recording area other than the first area for the second recording speed using the detected linear coefficient and the detected first writing power for the second recording speed, and output the control signal so that electrical current corresponding to the determined second writing power is provided to the optical pickup.

To further achieve at least the above objects or advantages in a whole or in part and in accordance with the purpose of the invention, as embodied and broadly described herein there is provided an apparatus that includes unit for determining a function representing writing power for the recording medium at a first recording speed, unit for detecting a writing power at a first area of the recording medium for at least one second recording speed other than the first recording speed and unit for setting a writing power at a recording area other than the first area for the second recording speed using the detected function representing writing power and the detected writing power for the second recording speed.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIGS. 1 and 2 illustrate an example of a related art zone-CLV recording method and divided zones on an optical disk according to the method;

FIG. 3 illustrates a block diagram of a preferred embodiment of an optical disk apparatus embodying the present invention;

FIG. 4 illustrates a flow diagram of a preferred embodiment of determining writing power according to the present invention;

FIG. 5a illustrates an exemplary graph for determining a linear coefficient at the standard recording speed;

FIG. 5b illustrates exemplary data stored in memory for obtaining optimal writing power; and

FIG. 6 illustrates relation between optimal writing power at a certain area for a recording speed and pre-stored optimal writing power data according to a preferred embodiment of the present invention.

### DETAILED DESCRIPTION OF PREFERRED EMBODIMENTS

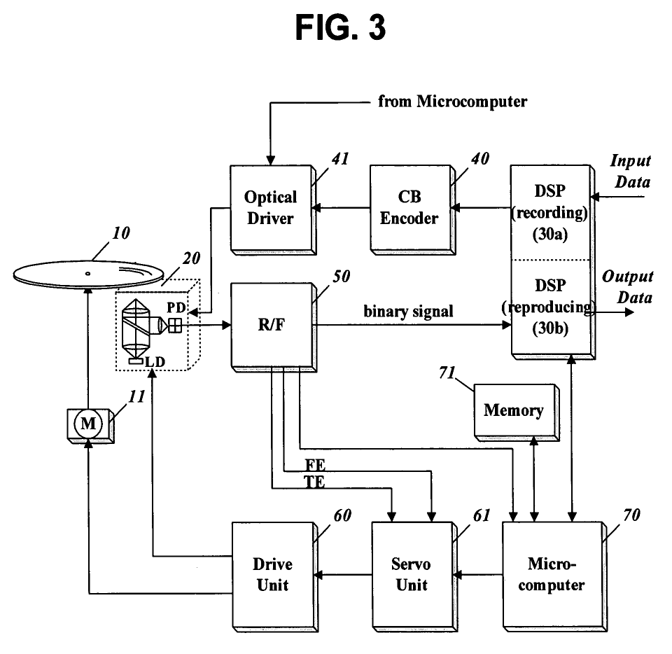

FIG. 3 illustrates a block diagram of an embodiment of an optical disk apparatus according the present invention. The apparatus can include a digital signal processor for recording 30a for converting input digital data into a recording format by adding ECC, etc, a channel bit encoder 40 for converting the data in the recording format into a bit stream, an optical driver 41 for providing electrical current according to the bit stream, and an optical pickup 20 for recording the bit stream on an optical disk 10 and detecting signals recorded on the optical disk 10 by irradiating light such as a laser beam onto the optical disk 10. The apparatus can further include an R/F unit 50 for generating a binary signal from the signal detected by the optical pickup 20 and generating focus/tracking error signals, a drive unit 60 for driving the optical pickup 20 and a spindle motor 11, and a servo unit 61 for controlling the drive unit 60 based on the focus/tracking error signals and the rotational speed of the optical disk 10. The apparatus can further include a digital signal processor for reproduction 30b for retrieving original digital data from the binary signal using a clock synchronized with the binary data, a memory 71 for storing data, and a microcomputer 70 for supervising overall operations of the apparatus, performing OPC (optimal power calibration) operation on the optical disk 10, and calculating optimal writing power setting for each recording speed of the optical disk 10. However, the present invention is not intended to be so limited because the OPC operations can be conducted by an additional elements, microcomputers or in combination with existing elements.

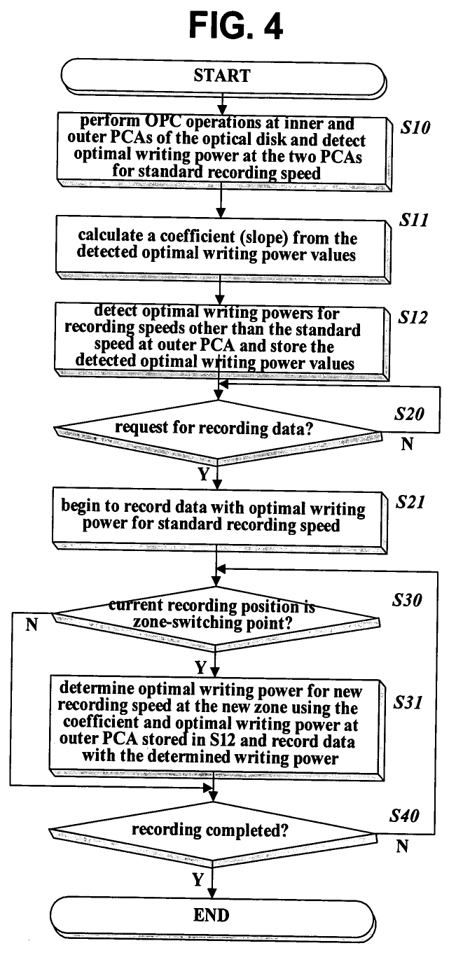

FIG. 4 illustrates a flow diagram of an embodiment of a method for determining writing power (e.g., OPC) according to the present invention. The method will now be described using and can be applied to the apparatus shown in FIG. 3. However, the present invention is not intended to be so limited.

DVD-R and DVD-RW disks can have PCAs (power calibration areas) reserved for performing laser power tests before actually writing data. PCAs can be, for example, both in the outer disk and in the inner disk to take account of differences of the disk characteristics at inner and outer tracks.

The method of determining optimal writing power according to FIG. 4 can perform OPC (optimal power calibration) operations at both of the PCAs placed in inner and outer tracks of the optical disk 10. The method of FIG. 4 can determine the optimal writing power at each recording speed based on the OPC result.

As shown in FIG. 4, if the optical disk 10 is loaded, the microcomputer 70 can move the optical pickup 20 to the inner part of the optical disk 10 where one PCA is located and perform OPC with the lowest recording speed (e.g., 4× speed) to obtain optimal writing power (Pop(4×)) at the recording speed.

First, the OPC operation can detect a reference optimum writing power (Pind) for the reference recording speed of the optical disk 10. The reference optimum writing power and reference recording speed data can be encoded in the pre-groove of the optical disk 10. We assume here that the reference optimum writing power is associated with 4× recording speed. However, the present invention is not intended to be so limited.

The microcomputer 70 can instruct the optical driver 41 to record predefined test data at the PCA with several different writing powers by slightly changing the writing power from the reference optimum writing power. For example, 15 data frames are recorded with 15 respective writing powers in one OPC process.

If recording of the test data is finished, the microcomputer 70 can control the optical pickup 20 to read the test data back at the PCA to judge the optimal writing power. The microcomputer 70 can search for the writing power yielding the highest jitter quality (Pin(4×)) and store the writing power and the address of the PCA showing the highest writing quality in the memory 71. The address can be obtained, for example, from information encoded in the wobble track or header information located at each boundary at which a land/groove switch occurs.

If the OPC operation is completed at the inner PCA, the microcomputer 70 can instruct the servo unit 61 to move the optical pickup 20 to the PCA placed at the outer area of the optical disk 10 and repeat the OPC operation to obtain the optimal writing power (Pout(4×)) at the outer PCA (block S10). The microcomputer 70 then can store the detected optimal writing power (Pout(4×)) and the address of the PCA showing the highest writing quality in the memory 71.

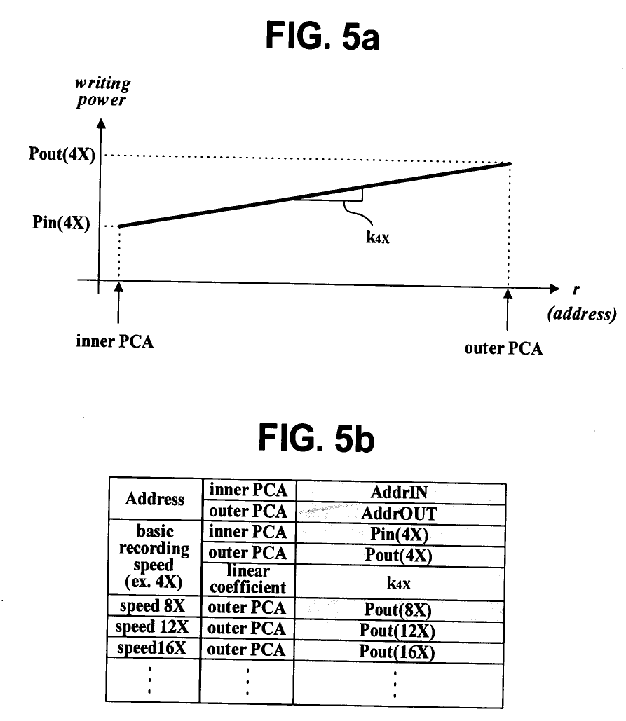

The microcomputer 70 can construct a linear graph as shown in FIG. 5a using the detected two optimal writing power settings (Pin(4×) and Pout(4×)) and calculate the slope of the line k₄ₓ connecting the two points (block S11). However, the present invention is not intended to be so limited as other calculatable approximations can be used according to characteristics of the disk to connect the detected writing power settings. The slope k₄ₓ indicates the variation of optimal writing power according to recording position at 4× recording speed. If there is no variation, the slope should be 0.

The microcomputer 70 can detect the optimal writing power settings for other recording speeds (e.g., 8×, 12×, 16×, etc) at the outer PCA in the same manner. The detected optimal writing powers (e.g., Pout (8×), Pout(12×), Pout(16×), etc) in the memory 71 can then be stored as shown in FIG. 5b (block S12).

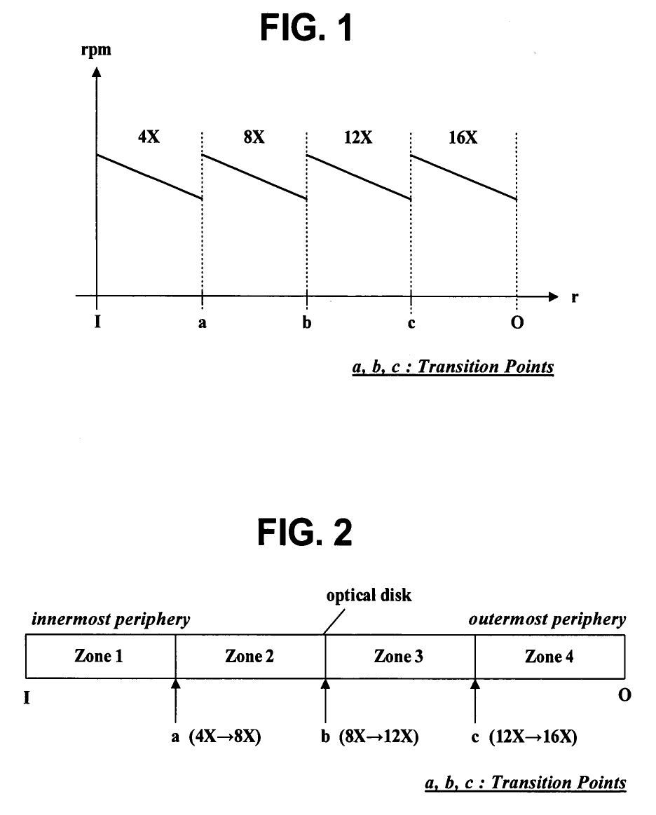

If a request for recording data is received (block S20), the microcomputer 70 can calculate optimal writing power at the target position before recording data or changing recording speed. The process for obtaining the optimal writing power will be described with respect to the zone-CLV writing method as shown in FIG. 1. However, the present invention is not intended to be so limited.

If the starting position to record data is within zone 1 (e.g., interval I-a) shown in FIG. 1, the microcomputer 70 can record input data at a designated recording speed for zone 1 (e.g., 4× speed) with the detected optimal writing power (Pin(4×)) (block S21). During the recording operation, the microcomputer 70 can keep detecting the current recording position to determine whether a switch to a higher recording speed should be done at the current position (block S30).

If the zone boundary (e.g., a in FIG. 1) is reached during the recording of data, the microcomputer 70 can switch from the current 4× speed to 8× speed, which is the designated recording speed for zone 2 (e.g., interval a-b in FIG. 1) by controlling the drive unit 60, determine optimal writing power for zone 2, and continue recording of data with the determined optimal writing power (block S31). The method to determine the optimal writing power for zone 2 can be as follows.

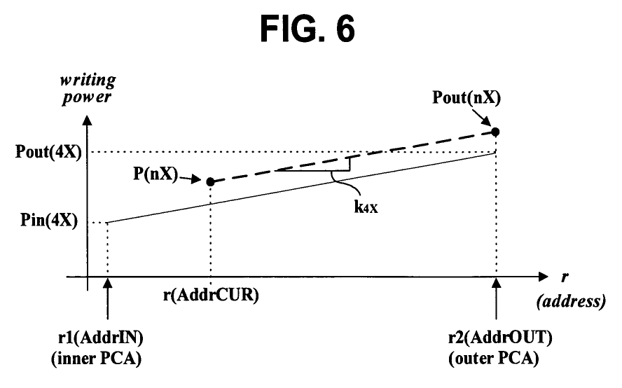

The microcomputer 70 first checks the designated recording speed for zone 2, (e.g., 8× speed) and reads the optimal writing power for 8× speed detected at the outer PCA (Pout(8×)), the slope (e.g., k_{4X}) obtained from the values of Pin(4×) and Pout(4×), and the addresses of the inner and outer PCAs (AddrIn and AddrOUT) where the OPC was performed from the memory 71. The optimal writing power (P(nX)) can be calculated from the following equation
P(nX)=Pout(nX)−k₄ₓ×(r2(AddrOUT)−r(AddrCUR)) (1)
where r2(AddrOUT)and r(AddrCUR) are the radius of the outer PCA and the radius of the current track on the optical disk 10, respectively. The method of calculating the radius of a track on a disk from the address thereof is well known. FIG. 6 illustrates an exemplary relation between the optimal writing power (P(nX)) calculated by equation (1) and optimal writing powers at inner and outer PCAs at the reference recording speed according to the embodiment shown in FIG. 4.

If Pout(nX) in equation (1) is replaced by Pout(8×), which is the optimal writing power for 8× speed obtained at the outer PCA, the optimal writing power at the current position for 8× speed P(8×) can be obtained. Likewise, if Pout(4×) is used in equation (1), the optimal writing power at the current position for 4× speed P(4×) can be obtained. Further, although the designated recording speed for zone 2 is 8× speed, Pout(4×) may be used at zone 2 when 4×-speed writing is requested or sufficiently high writing quality is not obtained with 8× speed.

If a next zone boundary (e.g., b or c in FIG. 1) is reached during recording of data at zone 2 with optimal writing power calculated by equation (1), the microcomputer 70 can read Pout(nX), the optimal writing power for the designated recording speed at the new zone, from the memory 71 and calculate optimal writing power for the new zone using equation (1). The microcomputer 70 can then record data on the optical disk 10 after adjusting the output of the optical driver 41 according to the calculated writing power.

In the preferred embodiment described above, the OPC operation can be performed at the inner and outer PCAs based on the reference writing power (Pind) recorded on the optical disk to obtain optimal writing power at respective PCAs (Pin and Pout) and a prescribed coefficient, (e.g., the linear coefficient) (k_{nX}), that is the slope of a line connecting Pin an Pout, is derived from Pin and Pout to calculate optimal writing power for different recording speeds. In one embodiment, a time required to run the OPC can be decreased by performing the OPC operation only at the outer PCA and calculating the linear coefficient using the optimal writing power obtained at the outer PCA (Pout) and the reference writing power (Pind) recorded on the optical disk.

Embodiments according to the present invention can be applied to a partial CAV recording method as well as the zone-CLV recording method. However, the present invention is not intended to be so limited.

The partial CAV recording method records data at increasing linear velocity from inner to outer tracks until a limit speed is reached and then recording of data is performed at a fixed speed (e.g., constant linear velocity, CLV). In the partial CAV recording method, the optimal writing power at each position at the CAV recording area can be calculated in the same manner as described above.

In addition, if the area at which data is recorded changes though the recording speed does not change, the optimal writing power at the recording position can be calculated using equation (1).

Although described as optimal power calibration (OPC) and OPC operations in this specification, the present invention is not intended to be so limited thereby. Embodiments using or describing OPC and OPC operations are intended to provide an improved power writing operations and/or levels relative to the related art, not “optimal” as generally defined.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As described above, embodiments of methods and apparatus for writing power for a recording medium have various advantages. For example, an embodiment of a method of determining writing power for an optical disk according to the present invention allows good writing quality by providing writing power that takes account of changes of disk characteristics and/or variation of optical characteristics of the apparatus. Further, embodiments allow stable reproduction of recorded data. Also, embodiments according to the present invention allows nonvolatile memory to be used for purposes other than storing writing power data.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A method comprising:
(a) obtaining a linear coefficient of writing power for a recording medium at a first speed;
(b) detecting a writing power at a first area of the recording medium for a second speed other than the first speed; and
(c) determining a writing power at a recording area other than the first area for the second speed using the detected linear coefficient and the detected writing power for the second speed.

2. The method of claim 1, wherein the area other than the first area for the second speed is one among a plurality of zones according to a zone-CLV.

3. The method of claim 2, wherein the area other than the first area for the second speed is a corresponding zone among a plurality of zones.

4. The method of claim 1, wherein the obtaining detects the linear coefficient of writing power using determined writing power values obtained by OPC (Optimal Power Calibration) operations performed at inner and outer areas of the recording medium with the first recording speed.

5. The method of claim 1, wherein the obtaining detects the linear coefficient using a reference writing power at the first recording speed recorded on the recording medium and a calculated writing power obtained by an OPC operation performed at a calculation area of the recording medium.

6. The method of claim 5, wherein the calculation area of the recording medium at which the OPC operation is performed is a power calibration area (PCA) reserved at an outer part of the recording medium.

7. The method of claim 1, wherein the first area is a power calibration area (PCA) reserved at the outer part of the recording medium.

8. The method of claim 1, wherein the detecting the writing power at the first area comprises:
recording test data on the recording medium with a plurality of writing power settings with the second recording speed; and
reading the recorded test data back to detect the writing power for the second speed based on the quality of signals reproduced from the recording medium.

9. The method of claim 1, wherein the determining determines the writing power for the second recording speed by the equation “(the writing power for the second recording speed)−(the linear coefficient)×(the distance between the current recording area other than the first area and the first area).

10. The method of claim 1, wherein the determining is performed each time the recording speed of the recording medium changes or each time the recording area of the recording medium changes at predetermined intervals.

11. The method of claim 1, wherein the first recording speed is the lowest speed among several recording speeds with which data recording is performed on the recording medium.

12. An apparatus, comprising:
an optical pickup configured to record signals on the recording medium and read the recorded signals from the recording medium;
an optical driver configured to provide the optical pickup with electrical current that determines the strength of the recorded signals according to a control signal;
a drive unit configured to rotate the recording medium; and
a controller configured to detect a linear coefficient of writing power for the recording medium while rotating the recording medium at a first recording speed using the drive unit, detect a first writing power at a first area of the recording medium while rotating the recording medium at a second recording speed different from the first recording speed using the drive unit, determine a second writing power at a second recording area other than the first area for the second recording speed using the detected linear coefficient and the detected first writing power for the second recording speed, and output the control signal so that electrical current corresponding to the determined second writing power is provided to the optical pickup.

13. The apparatus of claim 12, wherein the controller detects the linear coefficient using writing power values obtained by OPC operations performed at inner and outer areas of the recording medium with the first recording speed.

14. The apparatus of claim 12, wherein the controller detects the linear coefficient using a reference writing power at the first recording speed recorded on the recording medium and a writing power obtained by an OPC operation performed at an area of the recording medium.

15. The apparatus of claim 14, wherein the area of the recording medium at which the OPC operation is performed is a power calibration area (PCA) reserved at the outer part of the recording medium.

16. The apparatus of claim 12, wherein the first area is a power calibration area (PCA) reserved at the outer part of the recording medium, and wherein the first recording speed is the lowest speed among several recording speeds with which data recording is performed on the recording medium.

17. The apparatus of claim 12, wherein the controller determines the optimal writing power for the second recording speed by the equation “(the first writing power for the second recording speed)−(the linear coefficient)×(the distance between the second recording area other and the first area).

18. The apparatus of claim 12, wherein the controller detects a third writing power at a third area of the recording medium while rotating the recording medium at a third recording speed different from the first and second recording speeds using the drive unit, determines a fourth writing power at a fourth recording area other than the third area for the third recording speed using the detected linear coefficient and the detected third writing power for the third recording speed, and wherein the second recording area for the second speed and the fourth recording area for the third speed are in corresponding ones of a plurality of zones according to a zone-CLV.

19. An apparatus, comprising:
means for determining a function representing writing power for the recording medium at a first recording speed;
means for detecting a writing power at a first area of the recording medium for at least one second recording speed other than the first recording speed; and
means for setting a writing power at a recording area other than the first area for the second recording speed using the detected function representing writing power and the detected writing power for the second recording speed.
